(19) United States
(12) Patent Application Publication
(10) Pub. No.: US 2018/0038145 A1
(43) Pub. Date: Feb. 8, 2018

(54) HOUSEHOLD APPLIANCE COMPRISING A DOOR THAT CAN BE RETRACTED IN A STOWING AREA WITH SPECIFIC BEARING UNIT

(71) Applicant: BSH Hausgeräte GmbH, Munich (DE)

(72) Inventors: Konrad Bleier, Weisenbach (DE); Martin Brunner, Pforzheim (DE); Manfred Hintermayer, Karlsruhe (DE); Heiko Meyer, Königsbach-Stein (DE); Kerstin Sickert, Bretten (DE); Reinhard Wiedenmann, Weingarten (DE)

(21) Appl. No.: 15/549,388

(22) PCT Filed: Feb. 5, 2016
(86) PCT No.: PCT/EP2016/052477

§ 371 Date: Aug. 8, 2017

(30) Foreign Application Priority Data
Apr. 13, 2015 (DE) 10 2015 206 576.6

(51) Int. Cl. E05D 15/58; F24C 15/02

(52) U.S. Cl. CPC E05D 15/582; F24C 15/026; E05Y 2900/308

(57) ABSTRACT

A household appliance includes a housing surrounding an accommodation space and a door pivotable relative to the housing between a closing state in which the door closes a loading opening of the accommodation space and an opening state in which the door is retracted into a stowing area in the housing. A guide device is coupled to the door to guide the door during movement into and out of the stowing area. The guide device includes a bearing unit configured as a multi-articulated device which is mounted for rotation about an axis of rotation and includes guide elements. The multi-articulated device is configured such that a distance of the guide elements from one another and/or a distance of at least one of the guide elements to the axis of rotation is changeable depending on a position of the door.

The invention relates to a household appliance comprising a housing surrounding an accommodation space. The household appliance further comprises a door with which a loading opening of the accommodation space can be closed and which is arranged to be pivotable relative to the housing. In the opened state the door can be retracted into a stowing area in the housing, wherein the door is coupled to a guide device. The movement into and out of the stowing area is guided by the guide device. The guide device has at least one bearing unit which is rotatably mounted about an axis of rotation and on which guide elements are arranged. Moreover, the invention also relates to a method for opening and closing a door of a household appliance which may be retracted into a stowing area.

A household device comprising at least one door unit is disclosed in DE 10 2008 010 526 A1. The door unit is fastened by hinges to a housing of the household appliance and is pivotable relative thereto and in the open state may be retracted into a stowing area which is configured below the accommodation space. The hinges also comprise a U-shaped bracket as a hinge part, two rollers being rotatably mounted thereon. The bracket is rigid per se and pivotable about an axis of rotation.

A household appliance with a retractable appliance door is also disclosed in EP 2 57 378 A1. Also in this case a hinge with a U-shaped bracket is configured as a bearing unit in the form of a hinge rocker with two rollers. This hinge rocker is also rigid per se but rotatably arranged on a hinge housing.

The same is also disclosed in EP 2 574 712 A1, wherein the design of the hinge also provides a hinge housing and a bearing unit rotatably arranged thereon in the form of U-shaped bracket, which is a hinge hook.

As a result, a so-called technical part which comprises guide tracks for this bearing part and which receives rollers when the door is lowered has to be dimensioned accordingly. Moreover, by means of this design, in specific door positions when the door is already partially open and at the same time moves into the stowing area, a distance between the door leaf and the front upper edge on the front face which delimits the stowing area on the front face is very small. As a result, in the case of a further closing movement or during opening, it may potentially arise that the door leaf strikes against said front face. Relative to this vertical overall height, the critical points are the flange on the lower region and thus on the lower edge and the intermediate base of the aforementioned technical part which delimits the stowing area from above. This intermediate base forms, in particular, an upper cover of the stowing area. In the known embodiments, at the start of the opening movement the door is at a small distance from the flange and/or from the front edge of the intermediate base. The smallest vertical distance between the door and the intermediate base is present from the middle to the end of the opening movement of the door. Moreover, a relatively tall structure of the stowing area is required.

It is the object of the present invention to provide a household appliance and a method for opening and closing a door of a household appliance in which the guidance of the movement is improved and a smaller stowing area for the door is able to be configured.

This object is achieved by a household appliance and a method according to the independent claims.

A household appliance according to the invention comprises a housing surrounding an accommodation space. Moreover, the household appliance comprises a door with which a loading opening of the accommodation space can be closed. The door is arranged to be pivotable relative to the housing and in the opened state the door can be retracted into a stowing area in the housing. The door is coupled to a guide device with which the movement into and out of the stowing area is guided. The guide device has at least one bearing unit which is rotatably mounted about an axis of rotation and on which guide elements are arranged.

An essential idea of the invention is to be seen that the bearing unit has a multi-articulated device which has the axis of rotation and/or about which the entire multi-articulated device is rotatable and on which the guide elements are arranged. The multi-articulated device is also designed in such a way that a distance of the guide elements to one another and/or a distance of at least one guide element to the axis of rotation is changeable depending on the position of the door. The bearing unit is thus no longer configured as a bracket which is rigid per se, in particular a rigid U-shaped bracket, but by means of the multi-articulated device has a unit which is movable per se and is thus a deformable unit. Such a design permits the stowing area to be able to be of more compact configuration, whilst permitting the retracting movement of the door into the stowing area and the movement of the door out of the stowing area to be able to take place in an unrestricted manner and to be able to be carried out very easily relative thereto. With regard to the guidance of the movement of the door, therefore, there are no limitations. In particular, by means of the invention it is possible to configure the stowing area in its height and thus in vertical extent to be smaller and thus lower. As a result, the entire household appliance may be configured either to be compact or with the same height together with a larger cooking compartment, for example.

Preferably, it is provided that the multi-articulated device comprises a multi-articulated hinge. This is an advantageous embodiment, therefore, since by the design of the hinge a mechanically robust structure is also formed which remains continuously operational even in the case of extensive and repeated relative movement of the individual components of this multi-articulated hinge. Particularly with a multi-articulated hinge design, a very continuous and smooth movement of the parts of the bearing unit which are movable relative to one another is also achieved and thus a very smooth movement of the door into the stowing area or out of the stowing area is also achieved, but with a minimal height of the stowing area.

Preferably, it is provided that the multi-articulated hinge comprises a first articulated arm which is rotatably mounted about the axis of rotation on a base part of the multi-articulated device. As a result, the first articulated arm is arranged to be rotatably mounted on the axis of rotation on the base part. On the base part, a first guide element is mounted at a pivot point which is different from the pivot point formed by the axis of rotation. The rotational axes of the two pivot points are parallel. The multi-articulated hinge also comprises a second articulated arm which is rotatably connected to the pivot point of the first guide element and/or this pivot point forms the pivot point of the second articulated arm on the first articulated arm. This second articulated arm is also rotatably connected to the base part of the multi-articulated device at a further pivot point which is different from the pivot point formed by the axis of rotation. As a result, the second articulated arm is rotatably mounted on the base part at this further pivot point. In particular, a second guide element is rotatably mounted at the pivot point which is different from the axis of rotation. By means of this embodiment, the base part which is rigid per se, the first articulated arm which is rigid per se and the second articulated arm are in each case connected together such that virtually in each case one of these parts is always connected to the two other parts via individual pivot points. As a result, a design of the multi-articulated hinge embodiment which is inherently stable is achieved. A mutual guidance and/or effect of the movement of an articulated arm on the two other parts is thus achieved, whereby the improved guidance of the movement of the door into a more compact stowing area relative thereto is facilitated. In particular, in this case a distance between the guide elements is able to be changed depending on the position of the door, but the distances of the guide elements to the axis of rotation of the bearing unit and thus the entire multi-articulated device remain in each case the same.

In particular, in this embodiment it is also provided that the second articulated arm is in turn configured to be articulated and in this connection has two articulated arm parts which are connected so as to be rotatably mounted relative to one another.

Preferably, this second multi-part articulated arm is guided in a side profile of the door and is aligned by the movement, in particular the opening movement, of the door.

In particular, in this embodiment it is provided that by means of the first articulated arm which is rigid per se, the distance of the first guide element to the axis of rotation remains unaltered and also the distance of the second guide element to the axis of rotation remains unaltered, but the distance between the two guide elements is altered depending on the movement of the door and thus the position of the door.

In a further advantageous embodiment it is provided that the multi-articulated hinge comprises an articulated arm on which a first guide element is rotatably mounted at a pivot point. This articulated arm is rotatably mounted on a base part of the multi-articulated hinge comprising the axis of rotation. This articulated arm is mounted on a rotary device, for example a slot-guide, which does not have the axis of rotation. This multi-articulated hinge does not, therefore, have further components. This means that the articulated arm which is rigid per se is thus a freely projecting body which is rotatably connected only at one end to the base part. The base part which is rigid per se may be designed in this case, as in the aforementioned embodiment, in the manner of a bracket and, for example, be designed similar to a Y-shape or in the manner of a sickle.

Preferably in this reduced embodiment of the multi-articulated hinge it is provided that the articulated arm is rotatably mounted via a slot-guide on the base part. The slot-guide has, in particular, a sickle-shaped design so that a certain displacement of the articulated arm relative to the base part is also possible.

Preferably, the first guide element is arranged so as to be rotatably mounted on an end of the articulated arm remote from the base part.

In one embodiment of this multi-articulated hinge, it is provided that the second guide element is arranged so as to be rotatably mounted on an end of the base part remote from the axis of rotation.

In this embodiment of the multi-articulated hinge, however, it may also be provided that the second guide element is not arranged on the base part but is also rotatably mounted on the articulated arm.

In these embodiments it is provided that a distance is always constant between the two guide elements. Depending on whether the second guide element is arranged on the base part or on the articulated arm, only the distance of the first guide element to the axis of rotation is altered or alternatively the distance of both guide elements to the axis of rotation is altered when the door position is changed.

By the specific design using the slot-guide, which also represents a cut-out in the base part, a slight tilting of the doors via a specific angle is also permitted without the door having already been retracted into the stowing area. Depending on the type of geometric design, even with or without additional elements, a spring may be arranged in this slot-guide in order to improve the guidance of the articulated arm via a corresponding restoring force. In particular, in this case it is provided that during the tilting movement the door is rotated around a bearing bush until the predetermined opening angle is reached. With a further tilting movement the door then subsequently begins to move into the technical part and/or into the stowing area.

In a further embodiment, it may be provided that the multi-articulated device comprises an eccentric unit. By this design, a bearing unit which is movable per se may be provided, which represents a reduced constructional space in comparison with a rigid bearing unit with a rigid bearing bracket.

Preferably, it is provided that the eccentric unit comprises a rotary disk which, in particular as a rotary disk central point, comprises the axis of rotation of the entire bearing unit. The eccentric unit comprises a first articulated arm which is rotatably mounted on the rotary disk at a first pivot point which is different from the axis of rotation. In particular, a first guide element is rotatably mounted on the first articulated arm at a second pivot point of this first articulated arm. The eccentric unit also comprises a second articulated arm which is rotatably mounted on the rotary disk at a first pivot point which is different from the first pivot point of the first articulated arm. A second guide element is rotatably mounted on the second articulated arm at a second pivot point of the second articulated arm. A specification may also be achieved thereby which permits a particularly compact design of the stowing area, in particular with regard to its height.

Preferably, in this embodiment it is provided that the two articulated arms are connected by a connecting web, wherein the connecting web which is rigid per se is rotatably attached in each case to the second pivot point of the first articulated arm and is rotatably attached to the second pivot point of the second articulated arm.

In this embodiment comprising an eccentric unit, one respective distance of the guide elements to the axis of rotation is also able to be altered according to the position of the door, whereas the distance between the guide elements remains unaltered due to the connecting web which is rigid per se.

In a further embodiment in which the multi-articulated device is configured as a multi-articulated hinge, this multi-articulated hinge comprises a first articulated arm which comprises the axis of rotation. A first guide element of the bearing unit is rotatably mounted on the first articulated arm at a first pivot point which is different from the axis of rotation. The multi-articulated hinge also comprises a second articulated arm which is rotatably mounted on the first articulated arm at a second pivot point which is different from the axis of rotation and from the first pivot point. A second guide element of the bearing unit is rotatably mounted at a further different pivot point on the second articulated arm, wherein a rigid connecting web is rotatably mounted at the first pivot point of the first articulated arm and at the further pivot point of the second articulated arm. Also, a further embodiment is achieved thereby which permits a reduction of the stowing area. Here the alteration of the distance and/or the maintenance of the distance is configured as in the eccentric unit.

Moreover, the invention further relates to a method for opening and closing a door of a household appliance which is configured with a housing surrounding an accommodation space and with a door by which a loading opening of the accommodation space is able to be closed and in this case is arranged to be pivotable relative to the housing. In the opened state, the door is retracted into a stowing area in the housing, wherein the door is coupled to a guide device by which the guidance of the movement is guided into and out of the stowing area. The guide device is configured with a bearing unit which is rotatably mounted about an axis of rotation and on which guide elements are arranged. An essential idea of the invention is to be seen that, depending on the position and/or the movement of the door, a multi-articulated device of the bearing unit comprising the axis of rotation and the guide elements is adjusted such that a distance of the guide elements from one another and/or a distance of at least one guide element from the axis of rotation is altered. The advantages achievable thereby have been already cited relative to the household appliance.

Advantageous embodiments of the household appliance according to the invention are regarded as advantageous embodiments of the method according to the invention, wherein components of the household appliance corresponding thereto, in particular the bearing unit, are designed and movable relative to one another such that the respective movement sequences may be carried out.

By the terms “above”, “below”, “front”, “rear”, “horizontal”, “vertical”, “depth direction”, “width direction”, “vertical direction”, the intended use and intended arrangement of the device are indicated, and the positions and orientations are provided in the case of a viewer standing in front of the appliance and looking in the direction of the appliance.

Further features of the invention are disclosed from the claims, the figures and the description of the figures. The features and combination of features cited above in the description and the following features and/or combination of features cited hereinafter in the description of the figures and/or shown individually in the figures are not only able to be used in the respectively provided combination but also in other combinations or individually, without departing from the scope of the invention. Thus embodiments of the invention which are not explicitly shown and described in the figures but are revealed and able to be produced by separate combinations of features from the described embodiments are to be regarded as encompassed and disclosed. Also, embodiments and combinations of features, therefore, which do not have all of the features of an originally formulated independent claim are to be regarded as disclosed.

Exemplary embodiments of the invention are described in more detail hereinafter with reference to the schematic drawings, in which:

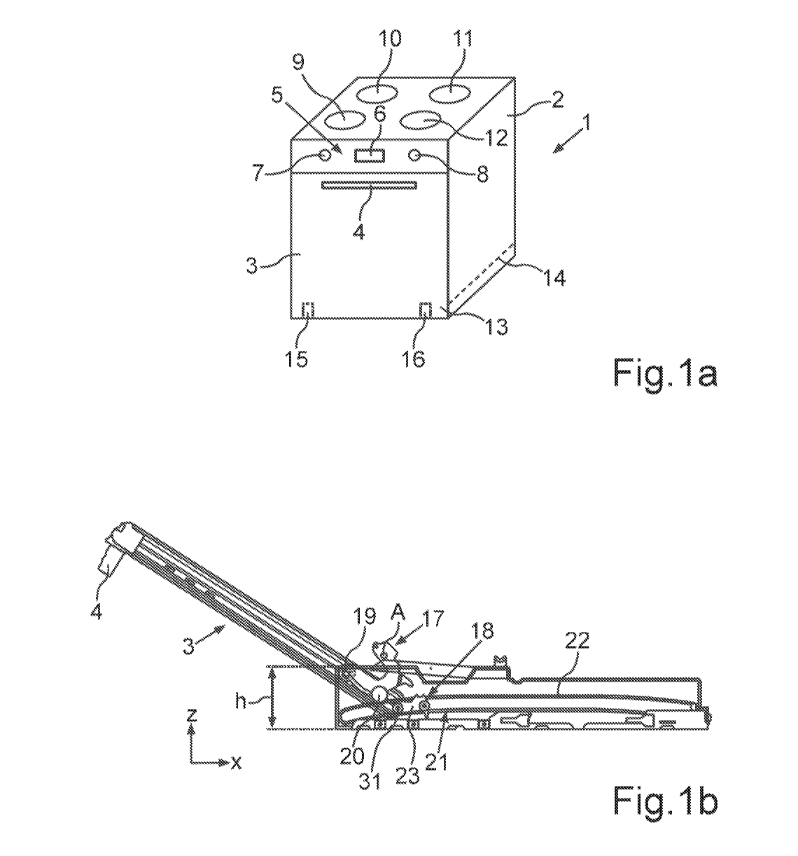

FIG. 1a shows a perspective view of an exemplary embodiment of a household appliance according to the invention;

FIG. 1b shows a side view of an exemplary embodiment of the household appliance with the door partially open;

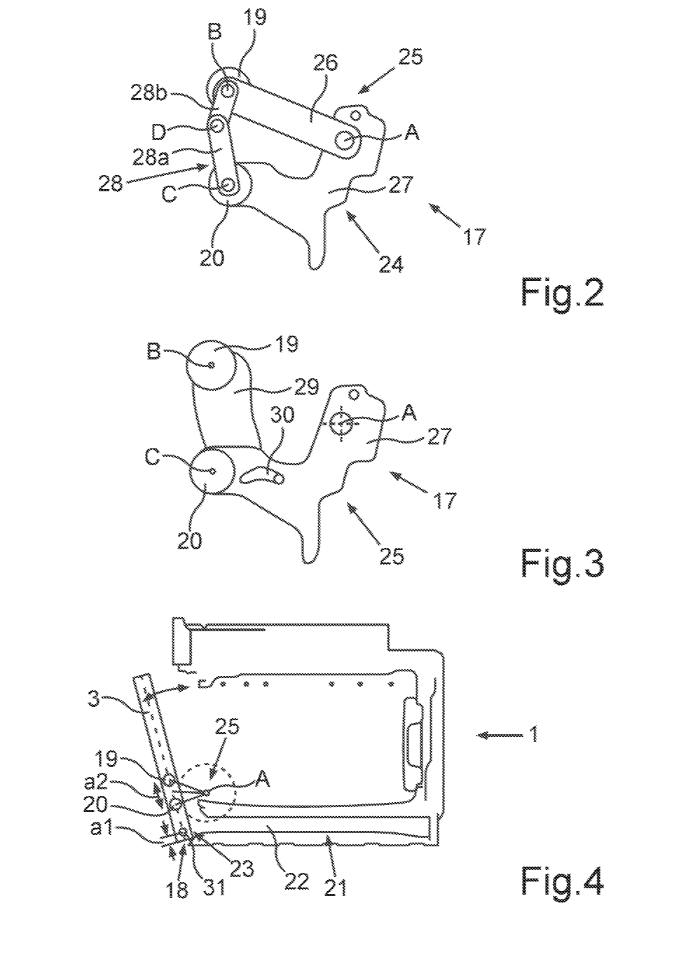

FIG. 2 shows a view of a first exemplary embodiment of a bearing unit of a guide device of the household appliance;

FIG. 3 shows a view of a second exemplary embodiment of a bearing unit of a guide device of the household appliance;

FIG. 4 shows a vertical sectional view of the household appliance with a bearing unit according to FIG. 3 and with the door partially open;

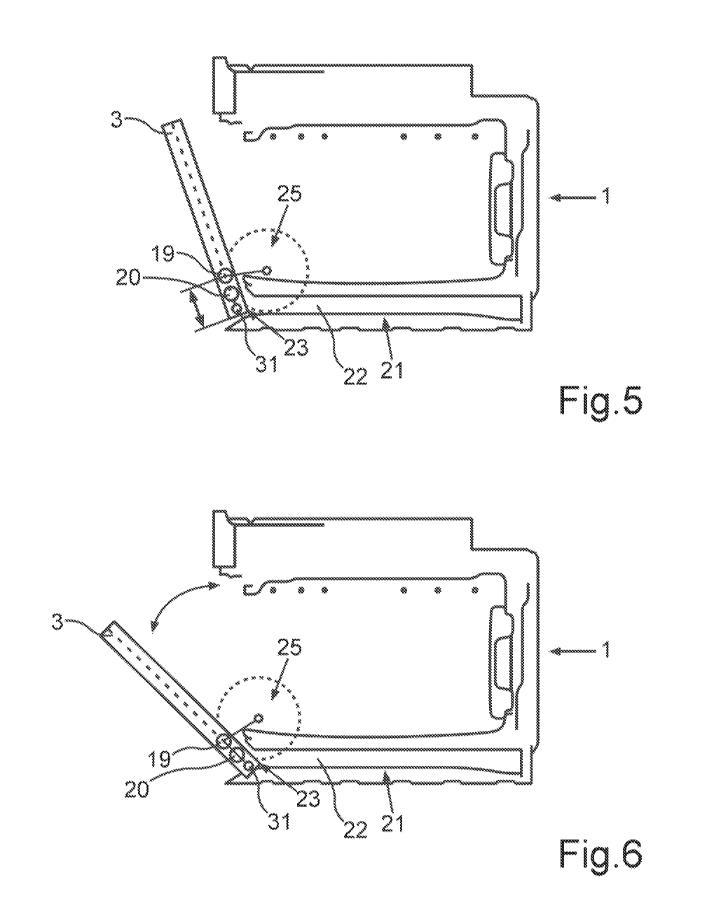

FIG. 5 shows a vertical sectional view of the household appliance with a bearing unit according to a further embodiment of the bearing unit and with the door partially open;

FIG. 6 shows the embodiment according to FIG. 5 with the door open further;

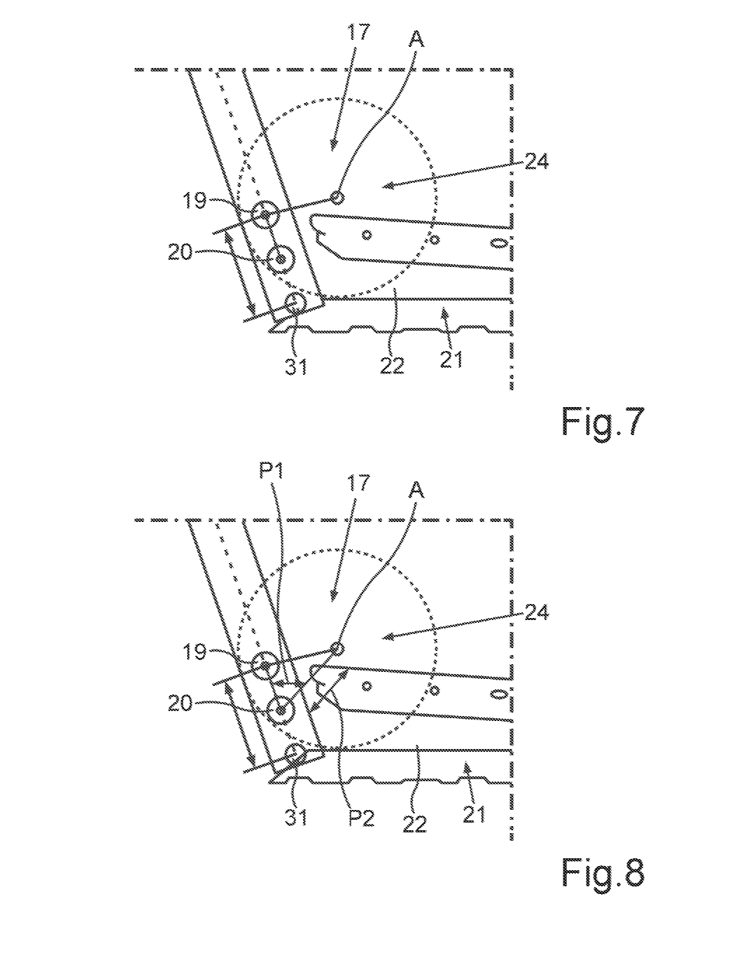

FIG. 7 shows an enlarged view of the bearing unit in the position of the door according to FIG. 5;

FIG. 8 shows an enlarged view of the bearing unit according to FIG. 5 in a further position of the door;

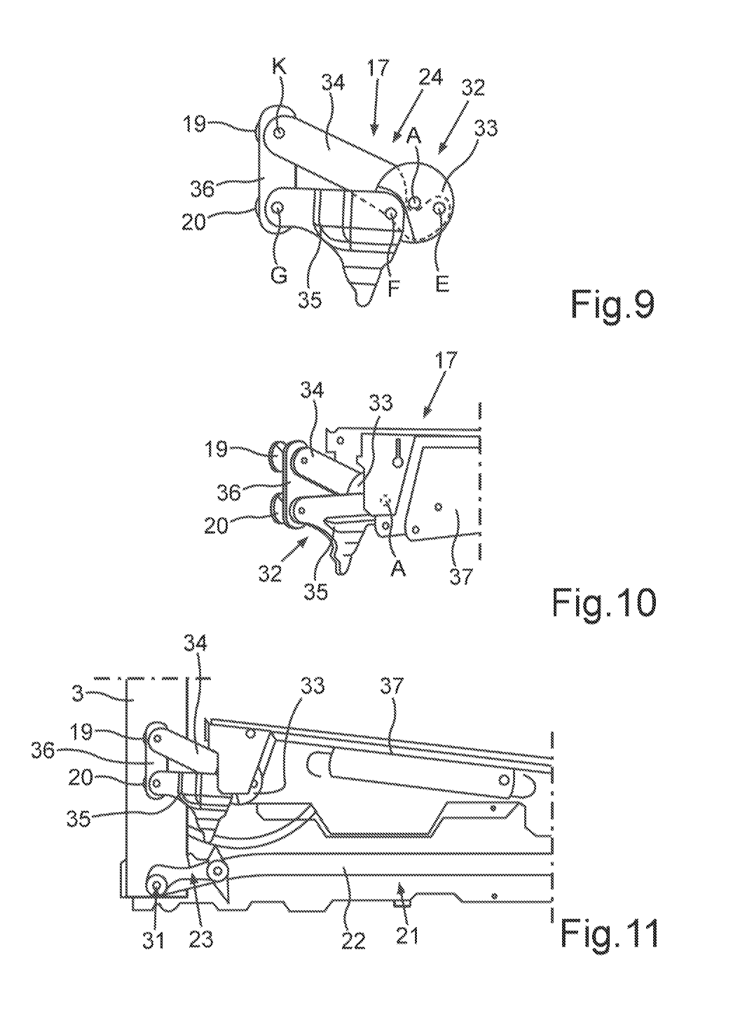

FIG. 9 shows a view of a further exemplary embodiment of a bearing unit of a guide device of the household appliance;

FIG. 10 shows a perspective view of an installed arrangement of the bearing unit according to FIG. 9;

FIG. 11 shows a side view of the household appliance with the arrangement according to FIG. 10; and

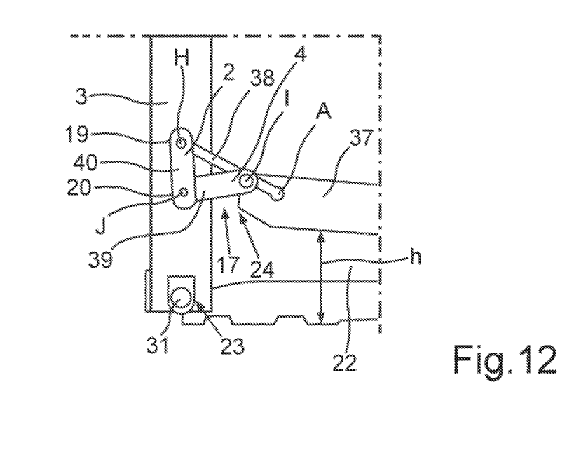

FIG. 12 shows a view of a further exemplary embodiment of a bearing unit of a guide device of the household appliance.

Elements which are the same or functionally the same are provided with the same reference numerals in the figures.

A household appliance 1 which is configured as an oven is shown in FIG. 1a in a schematic perspective view. The household appliance 1 comprises a housing 2 in which a cooking compartment defined by a heated chamber, not shown, is configured. Foodstuffs may be introduced into the cooking compartment for preparation. The cooking compartment is able to be closed on the front face by a door 3, which is shown in the closed end position in FIG. 1a. A handle 4 is configured on the front face of the door 3.

Moreover, the oven comprises an operating device 5 which, with regard to the position and display, comprises a display unit 6 and operating elements 7 and 8 only by way of example.

Moreover, with regard to the position and number, the cooking zones 9, 10, 11 and 12 are also shown only by way of example.

The door 3 in its lower region 13 may be pushed and/or retracted into the housing 2, which is the case when the door 3 is transferred from the closed end position shown in FIG. 1a into the fully open end position. The door 3 is then arranged pushed and retracted into a free space of the housing 2, wherein to this end a stowing area 14, arranged below the cooking compartment and separate therefrom by a corresponding partition, is configured by this free space.

The door 3 is connected to door hinges 15 and 16, which are shown and identified by way of example, and is pivotable thereby and able to be retracted into and moved out of the cited stowing area 14.

In FIG. 1b the household appliance 1 is shown in a side view in the lower region with the partially open door 3. A bearing unit 17 is shown. The bearing unit 17 represents a hinge hook of a hinge 15 and/or 16. The hinges 15 and 16 are configured, in particular, to be structurally the same and functionally the same, so that the following description also applies to one of the two hinges and also to the other in each case.

The hinges 15 and 16, in addition to one respectively provided bearing unit 17, also have a hinge housing which in this case is not shown in more detail. These hinges 15 and 16 are assigned in each case to a guide device 18, relative to the components and functions. The door 3 is guided in terms of movement by means of these guide devices 18 and as a result correspondingly coupled so that it is moved into the stowing area 14 and moved out of the stowing area 14. The bearing unit 17 comprises a pivot point which is arranged on an axis of rotation A which extends in FIG. 1b perpendicular to the plane of the figures. On this axis of rotation A the bearing unit 17, in particular, is also connected to the hinge housing and is pivotable relative to the hinge housing. The bearing unit 17 comprises two guide elements 19 and 20 which are configured as rollers and rotatably mounted on the bearing unit 17.

A vertical height h which shows the extent of a technical part 21 which forms part of the guide device 18 is illustrated in FIG. 1b. The technical part 21 describes, in particular, a component which has a groove and/or a guide track 22, in which the guide elements 19 and 20 are guided when sliding the door 3 into the stowing area 14.

For corresponding guidance, a slotted guide carriage 23 is also provided which slides along the guide track 22 and forms part of the guide device 18.

In FIG. 2 a first exemplary embodiment of the bearing unit 17 is shown. The bearing unit 17 is configured as a multi-articulated device 24 which in the example represents a multi-articulated hinge 25.

The multi-articulated hinge 25 comprises a first articulated arm 26 which is rigid per se and rotatably mounted about the axis of rotation A on a preferably Y-shaped base part 27 which is rigid per se of the multi-articulated hinge 25. On this first strip-shaped articulated arm 26 the first guide element 19 is rotatably mounted at a pivot point with an axis of rotation B. This axis of rotation B extends parallel to the axis of rotation A. The axis of rotation A is the hinge axis of rotation and thus the axis of rotation of the entire bearing unit 17.

The multi-articulated hinge 25 also comprises a second articulated arm 28 which is rotatably connected to the pivot point and thus the axis of rotation B of the first guide element 19 and, moreover, is rotatably connected to the base part 27 at a pivot point with an axis of rotation C which is different from the axis of rotation A. The second guide element 20 is also attached so as to be rotatably mounted at this pivot point with the axis of rotation C which is different from the axis of rotation A.

As may also be identified, the second articulated arm 28 is divided into two separate articulated parts 28a and 28b, which in turn are connected together so as to be rotatably mounted. Also here an axis of rotation D is arranged parallel to the axis of rotation A and the rotational axes B and C and thus perpendicular to the plane of the figures.

This second articulated arm 28 is preferably guided in a side profile of the door 3 and correspondingly aligned by the opening movement of the door 3.

In the embodiment shown in FIG. 2, the distance between the rotational axes B and C of the guide elements 19 and 20 is able to be altered depending on the position of the door 3. The distances of the guide element 19 and/or the axis of rotation B to the axis of rotation A remain constant due to the design of the articulated arm 26 which is rigid per se, and since the further guide element 20 is arranged on the base part 27 which also comprises the axis of rotation A, the distance between the rotational axes C and A also remains constant irrespective of the position of the door 3.

Moreover, a further exemplary embodiment of a bearing unit 17 is shown in FIG. 3. A multi-articulated hinge 25 is also configured in this case. Here, an articulated arm 29 which is rigid per se is configured on the base part 27 which is rigid per se, said articulated arm being rotatably arranged relative to the base part 27. In the exemplary embodiment the first guide element 19 is arranged so as to be rotatably mounted on the articulated arm 29, wherein the arrangement is such that the guide element 19 is positioned at an end remote from the base part 27.

In the exemplary embodiment shown here, the base part 27 comprises a cut-out and/or a slot-guide 30 which is configured to be curved and/or sickle-shaped. This embodiment with the slot-guide 30 permits a slight tilting of the door 3 at a specific angle, without the door 3 already having moved into the technical part 21 and thus into the stowing area 14. Depending on the type of geometric shape, a spring may also be mounted in the slot-guide 30 in order to improve the guidance of the articulated arm 29 via a corresponding restoring force. During the tilting movement the door 3 rotates about a bearing bush 31 (FIG. 4) until the predetermined opening angle is reached. Subsequently, the door 3 begins to move into the technical part 21, as shown in FIG. 4. FIG. 4 shows in this case a vertical sectional view of the household appliance 1.

In the embodiment according to FIG. 3 it is also provided that the second guide element 20 is rotatably arranged on the base part 27. In this embodiment, it is then provided that a distance remains constant between an axis of rotation of the guide element 20 and the axis of rotation A, irrespective of the position of the door 3. In contrast, the distance between the axis of rotation of the guide element 19 and the axis of rotation A is then altered. It may also be provided that in a further embodiment of the multi-articulated hinge according to FIG. 3, the second guide element 20 is also arranged on the articulated arm 29. By this embodiment the distance between the guide elements 19 and 20 remains constant but the distance between the guide element 20 and/or the axis of rotation of the guide element 20 and the axis of rotation A may also be altered.

The bearing bush 31 which, in particular, is a component of the guide device 18 is also shown in FIG. 4. Moreover, a distance a1 is illustrated which represents the distance of the bearing bush 31 relative to a door lower edge. By the distance a2, the distance is shown between the guide elements 19 and 20 in this specific position of the door 3.

In FIG. 5, a further vertical sectional view of the household appliance 1 is shown, in which the door 3 is also already partially open. In this embodiment, the multi-articulated hinge 25 is in turn configured with a base part 27 which is rigid per se and one or more articulated arms. With the opening movement of the door 3, the receiver and/or the slotted guide carriage 23 follows the guide track 22 in the technical part 21. After overcoming an incline in the guide track, as may also be identified in FIG. 1b, the receiver stops. As a result, a latching position is then adopted. The door 3 rotates about the bearing bush 31 which is pushed into the receiver by a specific angle. The opening angle of the door 3 is dependent on the path of curvature and on the time when the guide elements 19 and 20 tilt to the front via the geometry of the articulations. A distance from the upper guide element 19 to the bearing bush 31 is the same and/or unaltered until the latching position is reached. The latching position of the receiver is released only after the door 3 is horizontally oriented and the door 3 starts to move into the technical part 21. The upper guide element 19 or the lower guide element 20 is indirectly connected to the hinge pivot point and thus to the axis of rotation A. This connection is configured to be movable. The connection to the further lower hinge roller and/or to the lower guide element 20, or with a reverse design to the upper guide element 19, is implemented at a specific distance and angle from the upper arrangement of the guide element 19, but not directly connected to the pivot point and/or the axis of rotation A. The upper guide element moves on a fixed circular path. The lower guide element is guided through the side profile of the door 3.

In FIG. 6, the state is also shown in which the receiver remains in the respectively shown position and only moves further after the door 3 is fully open.

In FIG. 7, a further exemplary embodiment is shown in an enlarged view in which the bearing unit 17 is once again a multi-articulated device 24 which comprises one or more articulations and/or articulated arms. With the opening movement of the door 3, the receiver follows the guide track 22 in the technical part 21.

In FIG. 8, a further partial view is also shown, wherein, on the one hand, the angle between the articulated arms of the hinge and/or the multi-articulated device 24 is symbolized by the arrows P1 shown. The alteration to the distance between the guide element 20 and the axis of rotation A is shown by the further arrow P2.

In FIG. 9, a further exemplary embodiment of a bearing unit 17 as a multi-articulated device 24 is shown, wherein said bearing unit is configured in this case as an eccentric 32. In particular, it is provided here that this eccentric 32 has a rotary disk 33 which comprises the axis of rotation A. This eccentric 32 comprises a first articulated arm 34 which is rigid per se and which is arranged so as to be rotatably mounted on the rotary disk 33 at a first pivot point with an axis of rotation D which extends perpendicular to the plane of the figures and parallel to the axis of rotation A. The first guide element 19 is arranged so as to be rotatably mounted on the first articulated arm 34 which is rigid per se, wherein here an axis of rotation E is arranged at an end remote from the rotary disk 33. This second pivot point with the axis of rotation E is arranged at an end opposing the end on which the axis of rotation D is configured.

Moreover, the eccentric 32 comprises a further articulated arm 35 which is rigid per se and which is also arranged so as to be rotatably mounted on the rotary disk 33, wherein to this end a pivot point with an axis of rotation F is provided. The axis of rotation F in turn is arranged parallel to the axis of rotation D and to the axis of rotation A, wherein the pivot point with the axis of rotation F is different from the pivot point with the axis of rotation D.

The second guide element 20 is rotatably mounted on the second articulated arm 35, wherein here a pivot point is configured with an axis of rotation G, wherein this pivot point is different from the pivot point with the axis of rotation F.

Moreover, it is provided that this eccentric 32 is a connecting web 36 which is configured to be rigid per se and which is connected so as to be rotatably mounted in each case with the articulated arms 34 and 35. In particular, here the pivot points of the connecting web 36 are those with the axis of rotation E, on the one hand, and with the axis of rotation G, on the other hand.

In a preferred embodiment according to the view in FIG. 10, in which the eccentric 32 is arranged in a hinge housing 37, the eccentric 32 is positioned such that the rotary disk 33 is located inside this housing 37. In particular, it is provided that the first articulated arm 34 on the rotary disk 33 is fastened such that it still has a defined range of movement. The articulated arm 35 is also arranged on the rotary disk 33 but with a minimal range of movement.

By the opening movement of the door 3, due to the geometric arrangement the upper hinge arm and/or articulated arm 34 is “longer” and the second hinge arm and/or the lower articulated arm 35 is “shorter”. This has the result that the door 3 may move at a flatter angle into the guide track 22 of the technical part 21.

A side view of the embodiment according to FIGS. 9 and 10 of the bearing unit 17 in the installed state is shown in FIG. 11. The door 3 in this case is shown in the closed state. The receiver and/or the slotted guide carriage 23 are also able to be identified.

A further exemplary embodiment of the bearing unit 17 which is configured as multi-articulated device 24 is shown in FIG. 12. In this embodiment, once again a first articulated arm 38 which is rigid per se and which has the axis of rotation A is provided. The first guide element 19 is arranged in a pivot point with an axis of rotation H which is different from the axis of rotation A and which is provided parallel to the axis of rotation A of the hinge and/or the bearing unit 17. The bearing unit 17 also comprises a second articulated arm 39 which is rigid per se and which is rotatably mounted on the first articulated arm 38 at a further pivot point with an axis of rotation I which is different from the axis of rotation A and from the pivot point with the axis of rotation H. As may be identified, the pivot point with the axis of rotation I is arranged along the rigid first articulated arm 38 between the axis of rotation A and the axis of rotation H. The second guide element 20 is rotatably mounted on the second articulated arm 39 at a further different pivot point with an axis of rotation J. The bearing unit 17 also comprises a connecting web 40 which is rigid per se and which is rotatably mounted with the first articulated arm 38 and is connected to the second articulated arm 39. In this case it is provided that the connecting web 40 is rotatably mounted at the pivot point with the axis of rotation H, on the one hand, and at the pivot point with the axis of rotation J, on the other hand. Here an embodiment is implemented, therefore, in which levers and/or articulations are present which in each case have a separate pivot point in the hinge housing 37. By the opening movement of the door 3 and the receiver of the guide track 22, which follow a predetermined path of curvature, these two levers rotate about their respective pivot points and thus permit the pivoting of the door 3 into the technical part 21.

### LIST OF REFERENCE NUMERALS

1 Oven
2 Housing
3 Door
4 Handle
5 Operating device
6 Display unit
7 Operating element
8 Operating element
9 Cooking zone
10 Cooking zone
11 Cooking zone
12 Cooking zone
13 Region
14 Stowing area
15 Door hinge
16 Door hinge
17 Bearing unit
18 Guide device
19 Guide element
20 Guide element
21 Technical part
22 Guide track
23 Slotted guide carriage
24 Multi-articulated device
25 Multi-articulated hinge
26 Articulated arm
27 Base part
28 Articulated arm
28a Articulated part
28b Articulated part
29 Articulated arm
30 Slot-guide
31 Bearing bush
32 Eccentric
33 Rotary disk
34 Articulated arm
35 Articulated arm
36 Connecting web
37 Hinge housing
38 Articulated arm
39 Articulated arm
40 Connecting web
A Axis of rotation
B Pivot point
C Pivot point
D Axis of rotation
E Pivot point
F Pivot point
G Pivot point
H Pivot point
I Pivot point
J Pivot point
K Pivot point
a1 Distance
A2 Distance
P1 Arrow
P2 Arrow

1-13. (canceled)

14. A household appliance, comprising:
a housing surrounding an accommodation space;
a door pivotable relative to the housing between a closing state in which the door closes a loading opening of the accommodation space and an opening state in which the door is retracted into a stowing area in the housing; and
a guide device coupled to the door to guide the door during movement into and out of the stowing area, said guide device including a bearing unit having a multi-articulated device which is mounted for rotation about an axis of rotation and includes guide elements, said multi-articulated device being configured such that a distance of the guide elements from one another and/or a distance of at least one of the guide elements to the axis of rotation is changeable depending on a position of the door.

15. The household appliance of claim 14, wherein the multi-articulated device comprises a multi-articulated hinge.

16. The household appliance of claim 15, wherein the multi-articulated hinge comprises a base part, a first articulated arm which is mounted on the base part for rotation about the axis of rotation and on which a first one of the guide elements is mounted at a first pivot point, and a second articulated arm which is rotatably connected to the first pivot point of the first one of the guide elements and is rotatably connected to the base part at a second pivot point which is different from the axis of rotation.

17. The household appliance of claim 16, wherein a second one of the guide elements is rotatably mounted at the second pivot point.

18. The household appliance of claim 15, wherein the multi-articulated hinge comprises a base part configured to define the axis of rotation, and an articulated arm on which a first one of the guide elements is rotatably mounted at a first pivot point and which is rotatably mounted on the base part.

19. The household appliance of claim 18, wherein the articulated arm is rotatably mounted via a slot-guide on the base part.

20. The household appliance of claim 19, wherein the slot-guide is a sickle-shaped slot-guide.

21. The household appliance of claim 18, wherein the articulated arm is arranged in the absence of a direct attachment to the axis of rotation.

22. The household appliance of claim 18, wherein a second one of the guide elements is rotatably mounted on the base part at a second pivot point which is different from the axis of rotation.

23. The household appliance of claim 18, wherein a second one of the guide elements is rotatably mounted on the articulated arm at a second pivot point which is different from the first pivot point.

24. The household appliance of claim 14, wherein the multi-articulation device comprises an eccentric unit.

25. The household appliance of claim 24, wherein the eccentric unit comprises a rotary disk configured to define the axis of rotation, a first articulated arm defining a first pivot point via which the first articulated arm is rotatably mounted on the rotary disk and which is different from the axis of rotation, with a first one of the guide elements being rotatably mounted on the first articulated arm at a second pivot point of the first articulated arm, and a second articulated arm defining a first pivot point via which the second articulated arm is rotatably mounted on the rotary disk and which is different from the axis of rotation and from the first pivot point of the first articulated arm, with a second one of the guide elements being rotatably mounted on the second articulated arm at a second pivot point of the second articulated arm.

26. The household appliance of claim 25, wherein the eccentric unit includes a rigid connecting web configured to connect the first and second articulated arms, said connecting web being rotatably attached to the second pivot point of the first articulated arm and rotatably attached to the second pivot point of the second articulated arm.

27. The household appliance of claim 15, wherein the multi-articulated hinge comprises a first articulated arm configured to define the axis of rotation, with a first one of the guide elements being rotatably mounted on the first articulated arm at a first pivot point which is different from the axis of rotation, a second articulated arm which is rotatably mounted on the first articulated arm at a second pivot point which is different from the axis of rotation and from the first pivot point, with a second one of the guide elements being rotatably mounted at a further different pivot point on the second articulated arm, and a rigid connecting web rotatably mounted at the first pivot point of the first articulated arm and rotatably mounted at the further pivot point of the second articulated arm.

28. A method, comprising:
mounting a door to a housing of a household appliance for movement of the door between a closing state in which the door closes a loading opening and an opening state in which the door is retracted into a stowing area in the housing,
guiding the door during movement into and out of the stowing area via guide elements of a bearing unit which is mounted for rotation about an axis of rotation and configured as a multi-articulated device; and
adjusting the multi-articulated device depending on a position of the door such that a distance of the guide elements from one another and/or a distance of at least one of the guide elements to the axis of rotation is altered.
